(19) United States
(12) Patent Application Publication
(10) Pub. No.: US 2009/0086591 A1
(43) Pub. Date: Apr. 2, 2009

(54) OPTICAL DISC APPARATUS AND DETERMINATION METHOD OF OPTIMUM FOCUS POSITION

(75) Inventor: Tasuku SUDA, Tokyo (JP)

Correspondence Address: PILLSBURY WINTHROP SHAW PITTMAN, LLP, P.O. BOX 10500, MCLEAN, VA, 22102, US

(73) Assignee: KABUSHIKI KAISHA TOSHIBA, Tokyo (JP)

(21) Appl. No.: 12/236,859

(22) Filed: Sep. 24, 2008

(30) Foreign Application Priority Data
Sep. 27, 2007 (JP) 2007251657

(51) Int. Cl. G11B 7/00

(52) U.S. Cl. 369/44.23; G9B/7

(57) ABSTRACT

An optical disc apparatus includes: a light irradiation unit irradiating light to an optical disc to record and reproduce data; a focus position adjustment unit adjusting a focus position of the light irradiated from the light irradiation unit to the optical disc; a measurement unit measuring a correspondence relation between a light amount at a recording time of data to the optical disc at a predetermined focus position and a recording quality by controlling the irradiation unit; and a determination unit determining an optimum focus position based on a result of the measurement.

### CROSS-REFERENCE TO RELATED APPLICATIONS

This application is based upon and claims the benefit of priority from the prior Japanese Patent Application No. 2007-251657, filed on Sep. 27, 2007; the entire contents of which are incorporated herein by reference.

### BACKGROUND OF THE INVENTION

1. Field of the Invention

The present invention relates to an optical disc apparatus and a determination method of an optimum focus position.

2. Description of the Related Art

When data is recorded/reproduced to/from an optical disc, light condensing condition on the optical disc is controlled by using a focus error signal. Here, for the focus error signal, adjustment of offset may be necessary. The adjustment of offset of the focus error signal enables light to be condensed to an optimum focus position. For example, a technology is disclosed in which an optimum recording power is sought by OPC (Optical Power Control), and by using this optimum recording power, an optimum recording focus offset is sought (see JP-A 2004-86955 (KOKAI), paragraph number 0023).

### BRIEF SUMMARY OF THE INVENTION

Meanwhile, accurate detection of an optimum focus position is not necessarily easy. In view of the above, it is an object of the present invention to provide an optical disc apparatus enabling accurate detection of an optimum focus position and a determination method of the optimum focus position.

An optical disc apparatus according to a mode of the present invention includes: a light irradiation unit irradiating light to an optical disc to record and reproduce data; a focus position adjustment unit adjusting a focus position of the light irradiated from the light irradiation unit to the optical disc; a measurement unit measuring a correspondence relation between a light amount at a recording time of data to the optical disc at a predetermined focus position and a recording quality by controlling the irradiation unit; and a determination unit determining an optimum focus position based on a result of the measurement.

A determination method of an optimum focus position according to a mode of the present invention includes: measuring a correspondence relation between a light amount at a time of recording of data to an optical disc at a predetermined focus position and a recording quality; and determining an optimum focus position based on a result of the measurement.

### BRIEF DESCRIPTION OF THE DRAWINGS

FIG. 1 is a block diagram showing an optical disc apparatus according to a first embodiment.

FIG. 2 is an example of a graph showing a correspondence relation between a recording light amount and a recording quality.

FIG. 3 is a flowchart showing an example of operational procedures of the optical disc apparatus according to the first embodiment.

FIG. 4 is a flowchart showing an example of operational procedures of an optical disc apparatus according to a second embodiment.

FIG. 5 is an example of a graph showing a correspondence relation between a recording light amount and a recording quality.

### DETAILED DESCRIPTION OF THE INVENTION

Hereinafter, embodiments of the present invention will be described in detail with reference to the drawings.

### First Embodiment

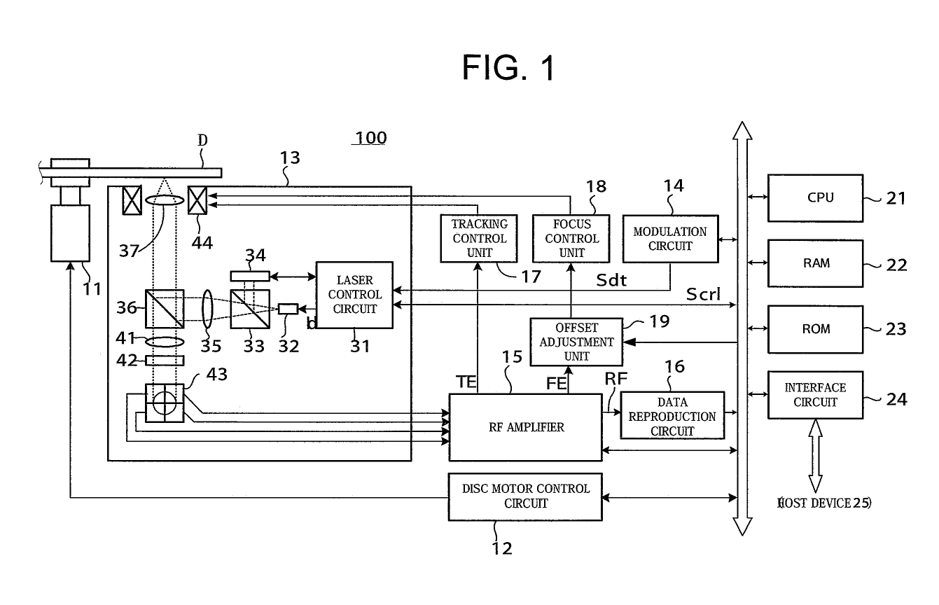

FIG. 1 is a block diagram showing an optical disc apparatus 100 according to a first embodiment of the present invention. The optical disc apparatus 100 records and reproduces information to/from an optical disc D.

The optical disc D is an information storage medium such as, for example, a DVD (Digital Versatile Disc) or an HD-DVD. A concentric circle grove or a spiral groove is made in the optical disc D. One round of the groove is called a track. An intensity modulated laser beam is irradiated along this track to form a mark (pit or the like), whereby user data is recorded. When the data is to be reproduced, a laser beam weaker than the laser beam at a recording time is irradiated along the track. The data is reproduced by detecting change in a reflected light intensity from the mark on the track.

The optical disc D is rotate-driven by a disc motor 11. The disc motor 11 is controlled by a disc motor control circuit 12. An optical pickup 13 irradiates light to the optical disc D to record/reproduce information. In other words, the optical pickup 13 functions as a light irradiation unit irradiating light to an optical disc to record and reproduce data.

At a time of information recording (at a time of mark formation), the user data is supplied from a host device 25 to a modulation circuit 14 via an interface circuit 24. The modulation circuit 14 EFM-modulates (for example, performs 8-14 modulation of) the user data and outputs it as a data signal Sdt to a laser control circuit 31.

The laser control circuit 31 supplies a write current (a drive current Id) to a semiconductor laser (a laser diode) 32 based on the data signal Sdt supplied from the modulation circuit 14. On this occasion, a control signal Scrl from a CPU 21 is used. At a time of information reading, the laser control circuit 31 supplies a read current (a drive current Id) smaller than the write current to the semiconductor laser 32.

A photo detector (front monitor) 34 detects a light amount (light-emitting power) of the laser beam generated by the semiconductor laser 32 and supplies a light amount detection current Ip to the laser control circuit 31. The laser control circuit 31 controls the semiconductor laser 32 based on the detection current from the photo detector 34. As a result, the semiconductor laser 32 emits light at a reproduction time laser power (reproduction light amount) and a recording time laser power (recording light amount) set by the CPU 21.

The laser beam emitted from the semiconductor laser 32 is irradiated onto the optical disc D via a half prism 33, a collimator lens 35, a half prism 36 and an objective lens 37. Reflected light from the optical disc D is led to a photo detector 43 via the objective lens 37, the half prism 36, a condenser lens 41 and a cylindrical lens 42. The photo detector 43 is constituted with, for example, a four divided photo-detection cells, and detection signals of these photo-detection cells are outputted to an RF amplifier 15.

The RF amplifier 15 processes the signal from the photo-detection cell and generates an RF signal, a tracking error signal TE and a focus error signal FE. The RF signal is a signal made by adding all the signals from the photo-detection cells, and reflected light from the mark formed on the track of the optical disc D is reflected therein. The tracking error signal TE indicates a deviation (error) between a beam spot center of the laser beam and a track center. The focus error signal FE is obtained from a difference between diagonal sums of the four-divided photo-detection cells (by an astigmatic method) and indicates a deviation (error) from a just focus for a recording layer of the optical disc D.

The RF signal is supplied to a data reproduction circuit 16 and the data is reproduced.

The tracking error signal TE and the focus error signal FE are supplied to a tracking control unit 17 and a focus control unit 18 respectively, so that a track drive signal and a focus drive signal are generated. The track drive signal and the focus drive signal are supplied to a drive coil 44, and the objective lens 37 is moved in a tracking direction (in a direction perpendicular to an optical axis of the lens) and in a focusing direction (in a direction of the optical axis of the lens). As a result, tracking servo (in which the laser beam always traces on the track formed on the optical disc D) and focus servo (in which the laser beam is always in just focus for the recording layer of the optical disc D) are performed.

An offset (focus offset) FE_{OFF} of the focus error signal FE is adjusted by an offset adjustment unit 19. By altering the focus offset FE_{OFF}, the objective lens 37 is moved in the optical axis direction, so that a focus position (light condensed position) of the laser beam irradiated from the optical pickup 13 to the optical disc D changes. The offset adjustment unit 19 stores the focus offset FE_{OFF} and adds it to the focus error signal FE. The focus offset FE_{OFF} stored by the offset adjustment unit 19 is appropriately altered by the CPU 21. The offset adjustment unit 19 functions as a focus position adjustment unit adjusting the focus position of the light irradiated to the optical disc D.

Due to a reason such as variation of a configuration of the optical pickup 13, a bias component (unnecessary DC component) may be generated in the focus error signal FE, requiring adjustment of the focus offset FE_{OFF}. When the bias component exists in the focus error signal FE, the focus position (light condensed position) is displaced from the recording layer, leading to a decreased recording quality. In the present embodiment, an optimum focus offset FE_{OFF} which corresponds to an optimum focus position is determined. The optimum focus position means that the laser beam is condensed on the recording layer of the optical disc D.

The CPU (Central Processing Unit) 21 comprehensively controls the optical disc apparatus 100 in accordance with an operation command provided from the host device 25 via the interface circuit 24. The CPU 21 uses a RAM (Random Access Memory) 22 as a work area and operates in accordance with a control program recorded in a ROM (Read Only Memory) 23.

The CPU 21 functions as the following 1) and 2) by operating in accordance with the control program.

1) a measurement unit measuring a correspondence relation between the light amount at the recording time of data to the optical disc D and the recording quality

2) a determination unit determining the optimum focus position (Correspondence Relation between Recording Amount and Recording Quality)

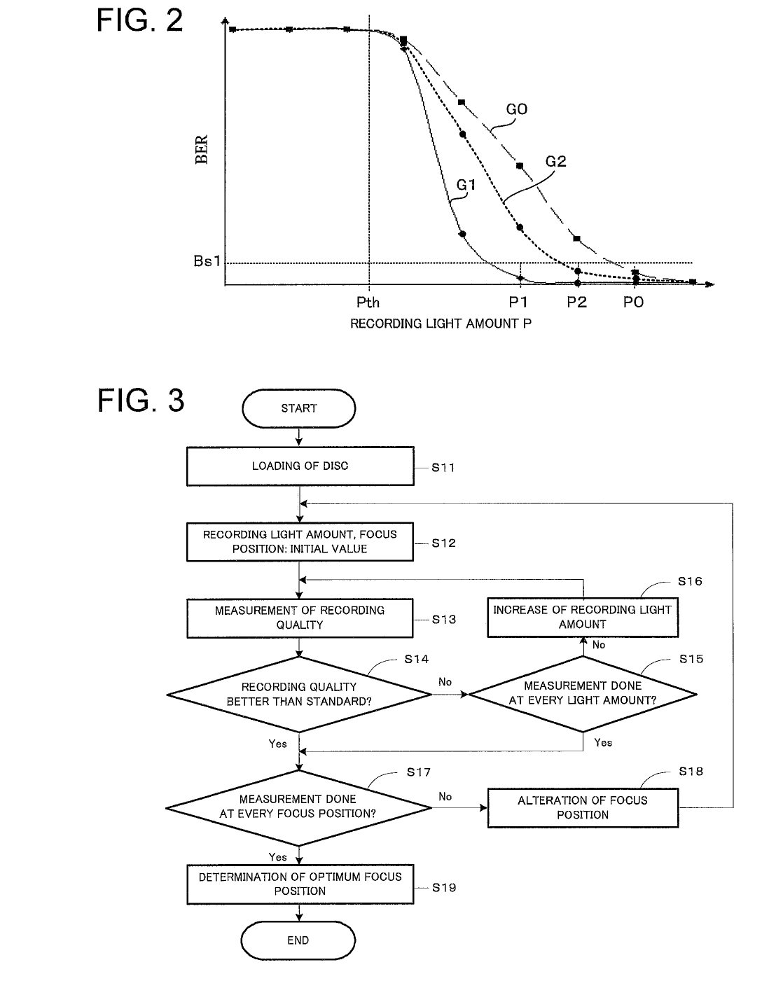

In the present embodiment, the optimum focus position is detected by using the correspondence relation between the light amount (recording time light amount) at the recording time and the recording quality. FIG. 2 is an example of a graph showing the correspondence relation between the recording light amount and the recording quality. A horizontal axis and a vertical axis in FIG. 2 respectively correspond to a recording light amount P [mW] and a byte error rate (BER). Graphs G1, G0 in FIG. 2 respectively represent relations between the recording light amounts P and the BERs at the optimum focus position and a focus position deviated from the optimum focus position.

The recording light amount P is a light amount (power) of the laser beam irradiated from the semiconductor laser 32 at the recording time. The recording light amount P can be altered by setting a light amount setting value N to the laser control circuit 31 by means of the control signal Scrl. The light amount setting value N is an integer between “0” (zero) to a predetermined maximum value M, and has a relation of P=A*N with the recording amount P (A: proportional constant).

The BER is a kind of index for a recording quality and means an occurrence rate of errors per one byte at the recording time of data to the disk D. More specifically, the BER is calculated by means of dividing the byte number of the erroneous data in the recorded data by the byte number of the recorded data. Predetermined data is recorded (written) to the optical disc D, thereafter the data is reproduced (read), and the recorded data and the reproduced data are compared, whereby an error is detected. In other words, a difference between the recorded data and the reproduced data is regarded as the error.

The following can be known from FIG. 2.

(1) When the recording light amount P is small, the BER is large (many writing errors occur). By making the recording light amount P large to some degree or more, the BER is decreased (writing errors are decreased). When the recording light amount P is made large enough, it is possible to make the BER small enough to be equal to or lower than a standard value Bs1 (for example, 10⁻⁴ to 10⁻⁵). The standard value Bs1 is a standard for allowable error occurrence in writing to the optical disc D. It becomes possible to allow occurrence of errors to some degree at the writing time by an error correction processing.

(2) When the recording light amount P is large enough, the BER is equal to or lower than the standard value Bs1 regardless of the focus position. This means that detection of the optimum focus position is difficult in a state that the recording light amount P is large. Conversely, usage of an intermediate recording light amount facilitates the detection of the optimum focus position.

(3) It is known from the graphs G1, G0 that the correspondence relation between the recording light amount and the BER changes depending on the focus position. In a case of the optimum focus position, the BER is decreased at a lower recording light amount (recording power), compared with a case of an unoptimum focus position. In the present embodiment, the optimum focus position is detected by using this characteristic.

It should be noted that a recording quality index other than the BER has a similar tendency. As recording quality indexes, a jitter and an error line number can be cited other than the BER.

The jitter means temporal deviation or fluctuation in the RF signal made by reproducing the data recorded in the optical disc D.

The error line number means the number of pieces of a series of data which are not corrected even by using a correction code included in the recorded data. For example, in a DVD, there exist a 5-byte correction code per a series of 182-byte data (ROW), and the series of data is error-corrected by using this correction code. When the series of corresponding data (of 182 byte) is not corrected by this correction code, the error line number is counted as “1”.

### (Operation of Optical Disc Apparatus 100)

An operation of the optical disc apparatus 100 will be described. FIG. 3 is a flowchart showing an example of operational procedures of the optical disc apparatus 100.

### (1) Loading of Optical Disc D (Step S11)

The optical disc D is loaded onto the optical disc apparatus 100. The CPU 21 detects the loading, and thereby a determination procedure of the optimum focus position (optimum focus offset FE_{OFF}) starts.

### (2) Measurement of Relation Between Recording Light Amount and Recording Quality (Step S12 to Step S16)

The correspondence relation between the recording light amount and the recording quality is measured by the following procedures.

1) The light amount (light amount set value N) and the focus position (focus offset FE_{OFF}) are set at initial values.

As the initial value of the light amount, a minimum light amount (light amount set value N is “0”) can be used. An appropriate value can also be the light amount (light amount set value N). As shown in FIG. 2, unless the recording light amount P exceeds a certain value Pth, the BER does not change. As the focus position, a zero-point value of the focus error signal FE can be used. In other words, the focus offset FE_{OFF} is set to be “0”.

2) The BER is measured.

The BER at a time that the light amount set value N and the focus offset FE_{OFF} are the initial values is measured. Thereafter, the recording light amount P is increased and the BER is measured. The data is written to a test write area of the optical disc D and the written data is read and compared, whereby the writing error is detected.

Measurement of the BER is repeated until the BER is measured at every light amount (until the light amount set value N reaches the maximum value M), or until the measured BER becomes equal to or smaller than the standard value Bs1. For example, in a case that the graph G0 corresponds to an initial value of the focus position, the BER is measured until the recording light amount P reaches from zero to P0. The recording light amount (recording power) P is increased sequentially from a low value, and recording and reproduction are performed. The recording light amount (recording power) Pat which the BER becomes equal to or smaller than the standard value Bs1 is stored.

The standard value Bs1 is a value in a range (tolerance range) where writing to the optical disc D is practically possible, for example, equal to or smaller than 10⁻⁴, more preferably equal to or smaller than 10⁻⁵. It should be noted, as already stated, that the jitter, the error line number or the like can be used instead of the BER.

### (3) Alteration of Focus Position (Step S17, Step S18)

When the measurement of the BER at the time of the focus position of the initial value is completed, the relation between the recording light amount and the recording quality is measured at the next focus position (step S12 to step S16). In other words, the focus offset FE_{OFF} is altered. An alteration range (size and width in alteration) of the focus position (focus offset FE_{OFF}) is determined in advance. As a result of the above, for example, in the graphs G0, G2, G1, recording light amounts (recording powers) P0, P2, P1 at which the BERs are equal to or smaller than the standard value Bs1 can be sequentially obtained.

### (4) Determination of Focus Position (Step S19)

The focus position when the light amount (recording power) P at which the BER is equal to or smaller than the standard value Bs1 is minimum is the optimum focus position. The recording light amount P at this time is referred to as a minimum recording light amount Pmin. The minimum recording light amount Pmin means a lower limit of the light amount enabling recording to the optical disc D. For example, when the graph G1 corresponds to the optimum focus position, the recording light amount P1 is the minimum recording light amount Pmin.

After the optimum focus position is determined, the optimum recording light amount is determined as necessary by OPC (Optimum Power Control) or the like. Data is recorded to the optical disc D at the optimum focus position (optimum focus offset FE_{OFF}) and the optimum recording light amount. It should be noted that usage of the minimum recording light amount Pmin in place of the optimum recording light amount decreases unnecessary damage to the optical disc D.

As described above, in the present embodiment, recording and reproducing are performed at several varieties of focus positions (focus offsets FE_{OFF}), with the recording light amount P being sequentially raised from the low power. A focus position is detected at which the recording light amount P is the lowest possible and the recording quality is good. As a result, the focus position (optimum focus offset FE_{OFF}) optimum for recording (and reproducing) data is determined.

Hereinafter, advantages of the present embodiment will be described.

### (1) Improved Accuracy of Determination of Optimum Focus Position

It becomes possible to accurately determine a focus position optimum for recording/reproducing of data to/from an optical disc D (for example, DVD-RAM). As a result, a recording quality is improved. Reproduction performance is also improved, so that error occurrence at a reproducing time is decreased. For example, it becomes possible to perform reliable reproduction from an optical disc D recorded by an optical disc apparatus (including an optical disc apparatus made by a different manufacturer) with a different specification (securing of reproduction compatibility). It becomes also possible to decrease an error frequency in a case of reproducing a defective optical disc D or an optical disc D in a bad recording state.

As a comparative example, a case is considered that a focus offset FE_{OFF} is determined after OPC. For example, data is recorded at an optimum recording light amount determined by the OPC and a recording quality such as a jitter is measured, whereby a focus offset FE_{OFF} is determined. In this case, an optimum recording light amount is determined at a focus position deviated from the optimum focus position. The optimum recording light amount at this time is, for example, the recording light amount P0 in FIG. 2, and the value is substantially larger than the minimum recording light amount Pmin (recording light amount P1 in FIG. 2). When the focus position is changed at such a large recording light amount, change in the recording quality (for example, BER) is small (see FIG. 2). Therefore, accuracy of the optimum focus position determined by such a method is low.

In contrast, in the present embodiment, as a result that the recording light amount is changed, the optimum focus position is determined by using a recording quality at a comparatively low recording light amount (for example, recording light amounts P2, P1 in FIG. 2). Consequently, change in the recording quality at the time that the focus position is changed is large, so that the optimum focus position can be determined more accurately.

### (2) Decreased Damage to Optical Disc D

In the present embodiment, by sequentially increasing a recording light amount, damage to an optical disc D is decreased.

### Second Embodiment

Hereinafter, an optical disc apparatus 200 according to a second embodiment of the present invention will be described. A basic configuration of the optical disc apparatus 200 is shown in FIG. 1, similarly to in the case of the optical disc apparatus 100 according to the first embodiment, and description will be omitted.

### (Operation of Optical Disc Apparatus 200)

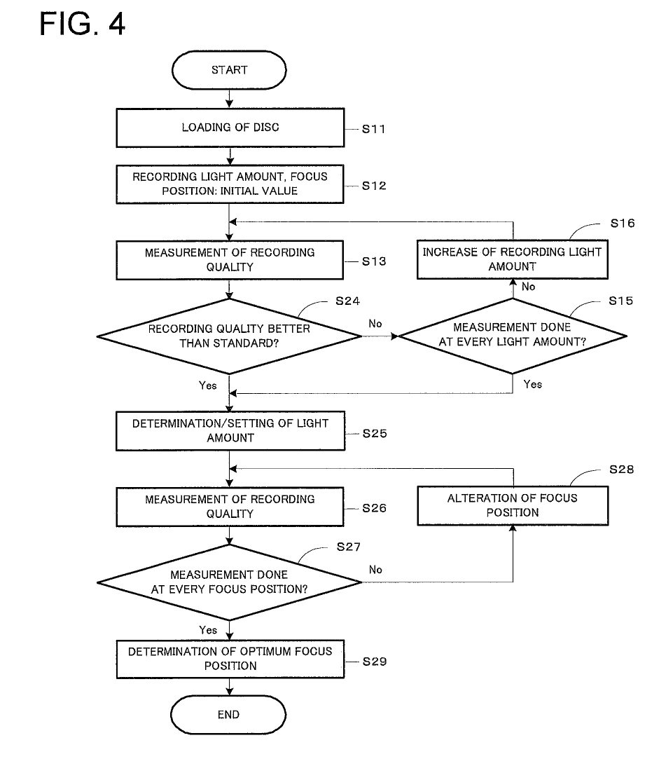

An operation of the optical disc apparatus 200 will be described. FIG. 4 is a flowchart showing an example of operational procedures of the optical disc apparatus 200.

### (1) Loading of Optical Disc D (Step S11)

An optical disc D is loaded onto the optical disc apparatus 200. A CPU 21 detects the loading, and thereby a determination procedure of the optimum focus position (optimum focus offset FE_{OFF}) starts.

### (2) Measurement of Relation Between Recording Light Amount and Recording Quality (Step S12, Step 13, Step S24, Step S15, and Step S16)

Measurement of a relation between a recording light amount and a recording quality is basically similar to that of the first embodiment, the recording light amount P being changed as the recording quality (BER) is measured. Measurement of the BER is repeated until the BER is measured at every light amount (until a light amount set value N reaches a maximum value M), or until the measured BER becomes equal to or smaller than a standard value Bs2.

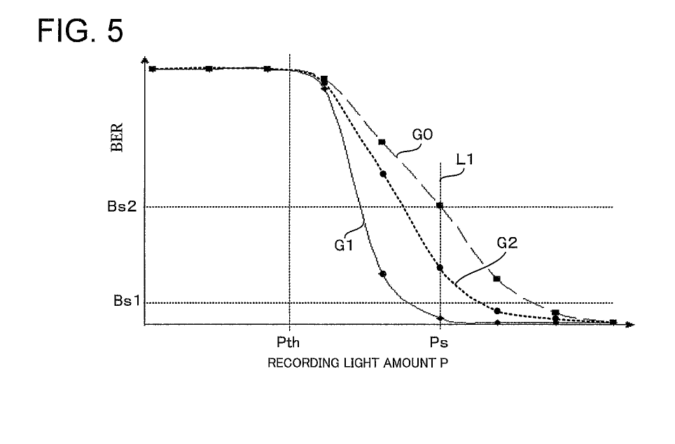

However, the standard value Bs2 at a step S24 is larger than the standard value Bs1 in the first embodiment (see FIG. 5). As is already described, the standard value Bs1 is the value in the range (tolerance range) where writing to the optical disc D is practically possible, for example, equal to or smaller than 10⁻⁴, more preferably equal to or smaller than 10⁻⁵. In contrast, the standard value Bs2 is a value in a range (range in which the recording quality is worse than in the tolerance range) where writing to the optical disc D cannot be said to be practically possible, for example about 10⁻² to 10⁻³. The standard value Bs2 is for selecting a recording light amount P at which change in a recording quality when the focus position is changed becomes large.

### (3) Determination/Setting of Recording Light Amount P (Step S25)

A recording light amount P corresponding to the standard value Bs2 is determined and a light amount set value N corresponding to the recording light amount P is set. A recording light amount P at a time that a BER is closest to the standard value Bs2 is selected. This is because the recording light amount P is not a consecutive amount but is a discrete amount, as is already described, and the recording light amount P can not be liberally selected. FIG. 5 shows an example of determination of the recording light amount P. For example, when the graph G0 corresponds to that of an initial value of a focus position, a recording light amount Ps is determined and set.

### (4) Measurement of Relation Between Focus Position and Recording Quality (Step S26 to Step S28)

A correspondence relation between the focus position and the recording quality is measured. In other words, measurement of the BER is repeated with the focus position being altered. The data is written to a test write area of the optical disc D and the written data is read and compared, whereby the writing error is detected.

Measurement of the BER is repeated until the BER is measured at every focus position. For example, the BER is measured on a line L1 of the recording light amount Ps. It should be noted, as is already described, that a jitter or an error line number can be used instead of the BER.

### (5) Determination of Focus Position (Step S29)

A focus position at which the BER is of a minimum value is regarded as an optimum focus position. Thereafter, a recording light amount is determined by OPC or the like. After the optimum focus position and the recording light amount are determined, data is recorded to the optical disc D at this optimum focus position (optimum focus offset FRO_{OFF}) and the recording light amount.

The present embodiment also has the following advantages similarly to the first embodiment.

(1) Improved Accuracy of Determination of Optimum Focus Position

(2) Decreased Damage to Optical Disc D

### Other Embodiment

Embodiments of the present invention are not limited to the above-described embodiments and can be expanded or altered, and expanded or altered embodiment is also included within a technical field of the present invention.

What is claimed is:

1. An optical disc apparatus, comprising:
a light irradiation unit irradiating light to an optical disc to record and reproduce data;
a focus position adjustment unit adjusting a focus position of the light irradiated from the light irradiation unit to the optical disc;
a measurement unit measuring a correspondence relation between a light amount at a recording time of data to the optical disc at a predetermined focus position and a recording quality by controlling the irradiation unit; and
a determination unit determining an optimum focus position based on-a result of the measurement.

2. The optical disc apparatus as set forth in claim 1,
wherein the measurement unit measures the correspondence relation between the light amount and the recording quality at a plurality of focus positions different from each other respectively; and
wherein the determination unit determines a focus position at a time that the recording quality is better than a predetermined standard and the light amount is minimum as an optimum focus position.

3. The optical disc apparatus as set forth in claim 1,
wherein the determination unit comprises:
a selection unit selecting a light amount corresponding to a recording quality worse than a predetermined tolerance range;
a second measurement unit measuring a correspondence relation between a focus position and a recording quality at the selected light amount; and
a judgment section judging that a focus position at a time that the measured recording quality is the best as an optimum focus position.

4. The optical disc apparatus as set forth in claim 1,
wherein the recording quality is specified by either one of an error included in data reproduced from the optical disc and a jitter included in a signal reproduced from the disc.

5. A determination method of an optimum focus position, comprising:
measuring a correspondence relation between a light amount at a time of recording of data to an optical disc at a predetermined focus position and a recording quality; and
determining an optimum focus position based on a result of the measurement.

6. The determination method of the optimum focus position as set forth in claim 5,
wherein in the measuring, the correspondence relation between the light amount and the recording quality at a plurality of focus positions different from each other is measured; and
wherein in the determining, a focus position at which the recording quality is better than a predetermined standard and the light amount is minimum is determined as an optimum focus position.

7. The determination method of the optimum focus position as set forth in claim 5,
wherein the determining comprise:
selecting a light amount corresponding to a recording quality worse than a predetermined tolerance range;
measuring a correspondence relation between a focus position and a recording quality at the selected light amount; and
judging that a focus position at a time that the measured recording quality is the best as an optimum focus position.

8. The determination method of the optimum focus position as set forth in claim 5,
wherein the recording quality is specified by either one of an error included in data reproduced from the optical disc and a jitter included in a signal reproduced from the disc.
